(19) United States
(12) Patent Application Publication
(10) Pub. No.: US 2005/0187811 A1
(43) Pub. Date: Aug. 25, 2005

(54) Method and system for managing excess inventory caused by fluctuating demand

(75) Inventors: Luis A. Freeman, Morrisville, NC (US); Dirk E. Morris, Raleigh, NC (US)

Correspondence Address: SAWYER LAW GROUP LLP, PO BOX 51418, PALO ALTO, CA, 94303, US

(73) Assignee: International Business Machines Corporation, Armonk, NY (US)

(21) Appl. No.: 10/783,582

(22) Filed: Feb. 20, 2004

(51) Int. Cl. G06F 17/60

(52) U.S. Cl. 705/10

(57) ABSTRACT

A method, system and computer readable medium for managing excess inventory of a commodity is disclosed. The method comprises creating a profile for the commodity, creating a waterfall template for the commodity, and analyzing the profile and the waterfall template to generate an output report, where the output report indicates the excess inventory and associated liability for a plurality of liability horizons.

### FIELD OF THE INVENTION

The present invention relates to outsourced manufacturing environments and more particularly to a method and system for managing excess inventory caused by fluctuating demand.

### BACKGROUND OF THE INVENTION

In an outsourced manufacturing environment, a product developer contracts with a supplier to manufacture a commodity which typically comprises one or more components. The product developer requests/demands a certain quantity of units manufactured per cycle, which is known as a demand forecast. The demand forecast typically indicates the number of units expected per week, for a series of weeks which make up a particular planning cycle. For example, one planning cycle can comprise thirteen (13) weeks and the demand forecast indicates the number of units expected for each of the thirteen weeks.

Based on the demand forecast, the supplier incurs expenses, e.g., buying sub-components and hiring workers, to meet the product developer's demand forecast. If the product developer reduces its demand forecast in a planning cycle, e.g. by reducing the number of expected units for a week(s) from a previous planning cycle to a current planning cycle, an excess number of units might be manufactured depending on which week(s) the demand change is implemented. For example if the product developer requests 1000 units to be delivered in three (3) weeks in a first planning cycle, and then in a second subsequent planning cycle reduces that request to 750 units, an excess inventory of 250 units results for that three (3) week period. Each unit comprises a set of components, and therefore, the excess inventory corresponds to 250 sets of components.

Typically a contractual agreement between the product developer and the supplier defines which party is held accountable for excess inventories that are created as a result of demand reductions. The liability for excess inventory is usually determined over predefined time horizons for each component that makes up the final assembly commodity. Thus, the product developer will be held accountable, i.e., liable, for any excess inventories that are created as a result of canceled orders within those defined time horizons.

It is common for the product developer to reduce forecasted demands within the time horizons of a commodity, and therefore, it is common that the product developer will become liable for the excess inventory of the commodity. Given the vast number of sub-components and varied defined time horizons, the product developer, however, is generally unaware of such liability until the supplier submits a claim to the product developer for payment for the excess inventory. At this time, the product developer must validate the supplier's claim. Currently, such validation is estimated by collecting historical demand forecasts for several previous planning cycles and the corresponding consumption data, manually entering such values into spreadsheets, and analyzing the spreadsheets to determine the excess, which in turn determines the liability. In addition to consuming enormous amounts of time, this validation process can overestimate the product developer's liability because it often ignores the time horizons defined by the terms and conditions of the contract between the product developer and the finished good commodity supplier.

Moreover, because the supplier's claim is often submitted several months after a commodity is withdrawn from the market place, the product developer's ability to take appropriate actions to minimize potential losses is severely limited. In other words, because the product developer is not aware of the excess inventory created as a result of a reduction at the actual time of the reduction, the product developer cannot take appropriate actions to mitigate or eliminate the excess inventory such a reduction has potentially created.

Accordingly, a need exists for a system and method that tracks and manages excess inventories based on demand fluctuations and the contract terms and conditions. The system and method should provide real-time and ongoing liability analysis during the life cycle of a commodity. In addition, the system and method should be highly automated, requiring little if any user interaction. The present invention addresses such a need.

### SUMMARY OF THE INVENTION

The present invention is directed to a method, system and computer readable medium for managing excess inventory of a commodity. The method comprises creating a profile for the commodity, creating a waterfall template for the commodity, and analyzing the profile and the waterfall template together to generate an output report, where the output report indicates the excess inventory and associated liability for a plurality of liability horizons.

### BRIEF DESCRIPTION OF THE DRAWINGS

FIG. 1 illustrates a block diagram of the system in accordance with a preferred embodiment of the present invention.

FIG. 2 is a flowchart illustrating a process for managing excess inventory according to a preferred embodiment of the present invention.

FIG. 3 is an exemplary liability profile according to a preferred embodiment of the present invention.

FIG. 4 is an exemplary waterfall template according to a preferred embodiment of the present invention.

FIG. 5 illustrates is an exemplary liability output report according to a preferred embodiment of the present invention.

### DETAILED DESCRIPTION

The present invention relates to outsourced manufacturing environments and more particularly to a method and system for forecasting and managing liability caused by on-going fluctuating demand. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

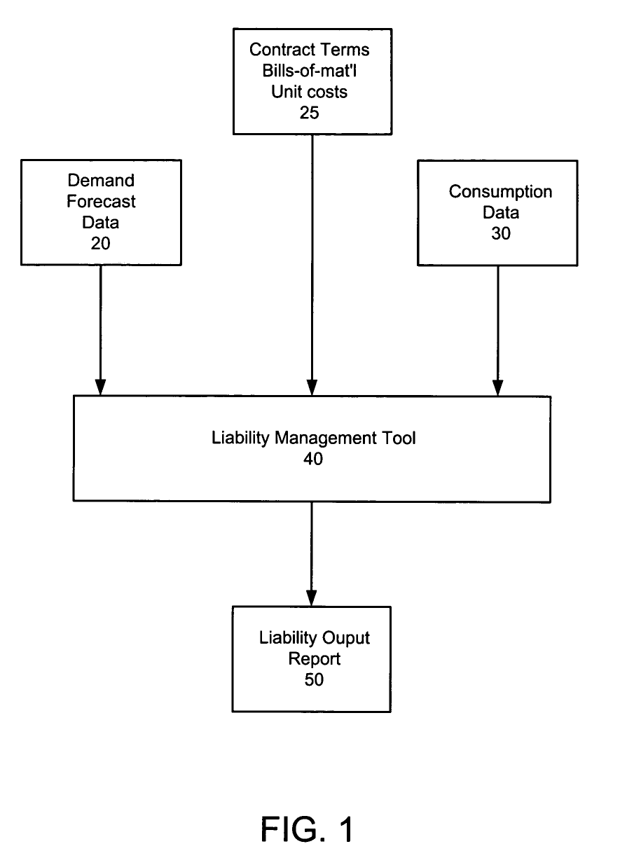

According to a preferred embodiment of the present invention illustrated in FIG. 1, a liability management tool 40 automatically collects, at a minimum, historical and current demand forecast information 20, historical and current consumption data 30, contract terms and conditions, and component costs and bills-of-material 25 from the various data sources. With this information, the liability management tool 40 generates a liability profile that incorporates the contract terms and conditions and the component costs and bills-of-material. The liability management tool 40 also generates a waterfall template or demand cascade that consolidates the historical demand forecasts, current cycle's demand forecast and actual consumption data. By analyzing the liability profile and the waterfall template together, the liability management tool 40 generates a liability output report 50 which indicates, in quantity or dollar amount, the excess inventory of each component in the commodity for the current cycle given the current demand forecast.

The liability output report 50 provides real-time and on-going liability creation and dissipation based on demand fluctuations and contract terms and conditions. The report 50 can be used to predict and quantify liability for excess inventories, and to prompt appropriate actions by the product developer to minimize such excesses. In addition, the product developer can easily and quickly validate liability claims submitted by a supplier.

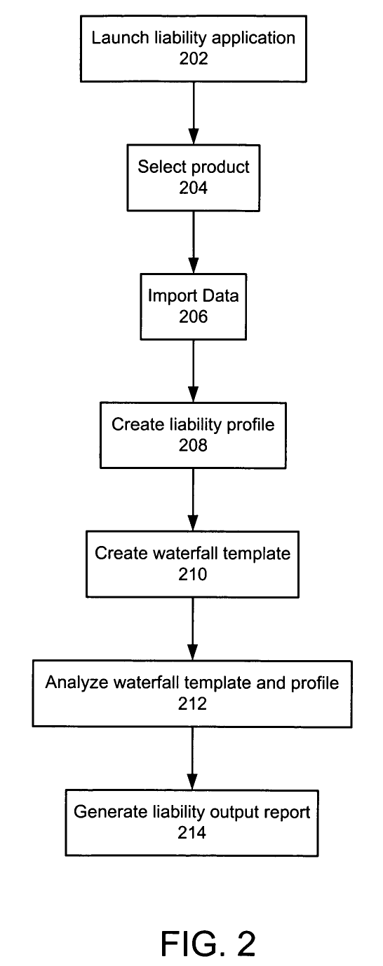

FIG. 2 is a flowchart illustrating a process for tracking excess inventory according to a preferred embodiment of the present invention. The process begins at step 202 by launching the liability management tool 40, which is preferably an application comprising program code that when executed by a processing system performs the functions of the present invention. In a preferred embodiment, the tool 40 can be launched periodically, e.g., weekly or whenever a cycle is initiated. In step 204, a commodity is selected 204 for analysis. Once the commodity is selected, the liability management tool 40 imports relevant data elements pertaining to the commodity in step 206. The imported data elements include commodity cost information and the contract terms with the supplier 25, current and past demand forecasts 20, and current and past consumption data 30. Each imported data element can reside in a different data source or database table. The management liability tool 40 will generate the appropriate requests to extract the relevant data elements from the respective data sources.

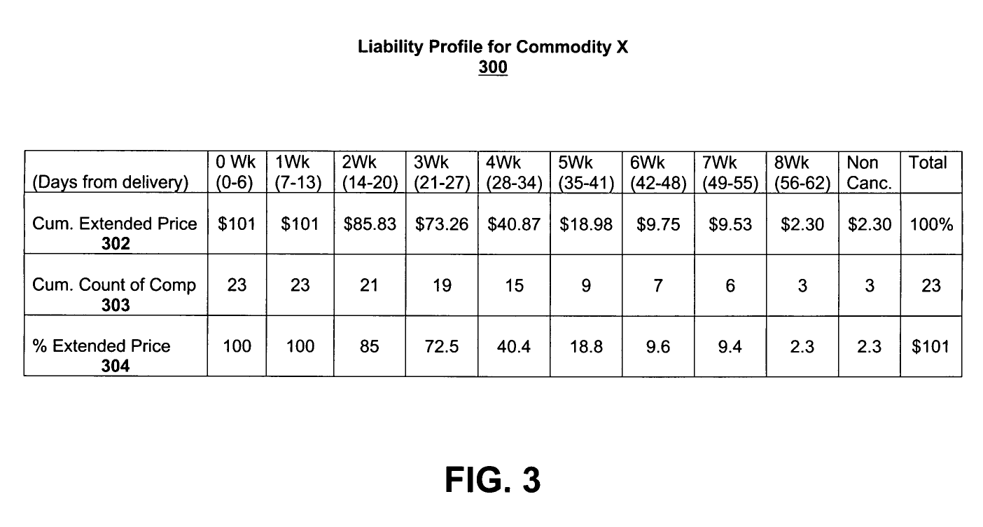

In step 208, the management liability tool 40 creates a liability profile for the commodity based on the commodity cost information, bills-of-material, and contract terms and conditions 25. FIG. 3 is an exemplary liability profile 300 according to a preferred embodiment of the present invention. As is shown, the liability profile 300 comprises cancellation windows for a given commodity at a given week during the production process. The cumulative extended price 302 represents the liability per unit, in dollars, at that week for one excess unit. So, for example, the product developer's liability for an excess unit of commodity X one week, e.g., 7-13 days, from the time of delivery is $101. Whereas the liability for an excess unit during week seven (7), i.e., between 49 and 55 calendar days from delivery, is $9.53.

The difference in liability reflects the contract terms and conditions between the supplier and product developer, where the supplier has agreed to allow the product developer to cancel certain sub-components that comprise the commodity at certain times without incurring liability. The cumulative count of components 303 represents the number of components that are non-cancelable within a certain number of weeks from the scheduled delivery date. Thus, as would be expected, the number of non-cancelable sub-components increases as the date of delivery approaches. For example, at week eight (8), i.e., 56-72 days from delivery, merely three (3) of a total of 23 sub-components are non-cancelable, totaling a cost of $2.30 per unit in excess. Whereas, at week three (3), i.e., 21-27 days from delivery, 19 of 23 sub-components are non-cancelable, totaling a cost of $73.26 per unit in excess.

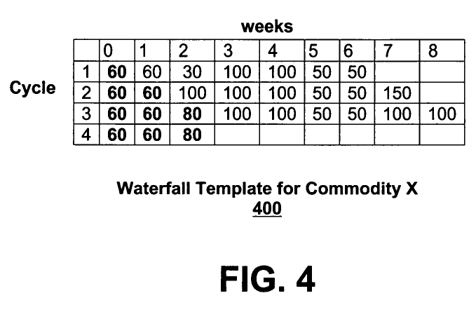

Referring again to FIG. 2, the liability management tool 40 also creates a waterfall template from the demand forecast data 20 and the consumption data 30 in step 210. FIG. 4 is an exemplary waterfall template 400 according to a preferred embodiment of the present invention. As is shown, the waterfall template 400 is a consolidation of historical demand forecasts, a current planning cycle's demand forecast and the actual consumption. In FIG. 4, each row includes the demand forecast for a particular six-week planning cycle. Those skilled in the art readily appreciate that a planning cycle can comprise of several weeks and is not limited to six weeks. The entries in bold print are the number of units actually consumed by the product developer between a last cycle and a current cycle.

Thus, for example, in FIG. 4, the current cycle is cycle 3 and the demand forecast comprises orders for 100, 100, 50, 50, 100, and 100 units for the next six weeks respectively. This demand forecast differs from the forecast of the previous cycle (cycle 2) where the demand for week 7 is reduced from 150 units (cycle 2) to 100 units (cycle 3). This reduction can potentially expose the product developer to liability for excess inventory. The product developer has consumed, i.e., pulled from a distribution hub and taken product title, 80 units between the previous cycle (cycle 2) and the current cycle.

Referring again to FIG. 2, once the liability management tool 40 creates the liability profile 300 and the waterfall template 400 for the selected commodity, the liability management tool 40 analyzes the waterfall template 400 and liability profile (step 212) and calculates: cumulative excess quantity and cumulative excess dollar figures for specific liability horizons. The following discussion describes how such quantities are calculated according to a preferred embodiment of the present invention.

1. Excess Quantity Calculation Formulas

Non-cancelable sub-components (or components) are treated differently than those components having a cancellation window. Therefore two different sets of calculations are presented below. Section 1.1 details the formulas used to calculate the excess quantity for those components having a cancellation window. The calculation buckets rely on a liability horizon. The liability horizon is a specified period of time, expressed in weeks, within which quantities are calculated from cycle to cycle.

Section 1.2 describes the formulas used to calculate non-cancelable components. The calculation buckets rely on a Manufacturing Lead Time (MLT), which is the sum of the number of weeks needed to manufacture and store the commodity (Pipeline) and the number of weeks needed to order a component (component lead time). The MLT is used to determine how far in advance to place demands for a component that is non-cancelable.

1.1 Formulas for Components Having a Cancellation Window

1.1.1 Cuts

Cuts is a bi-dimensional matrix that calculates the difference between the demands in a current cycle and a previous cycle for a specified liability horizon. As stated above, the liability horizon is a window of time in which the analysis will be applied and is typically set by the user. The number of cuts is calculated by the following formula:

$${Cuts}_{h , c} = {\sum }_{n = c - 1}^{n = c + h - 2} {Req}_{n , c} - {\sum }_{n = c - 1}^{n = c + h - 2} {Req}_{n , c - 1}$$

where, h is the Liability Horizon expressed in weeks, and c is the cycle being calculated.

1.1.2 Cumulative Cuts

Cumulative cuts is a bi-dimensional matrix calculating the cumulative effect of cuts across cycles for a specified liability horizon. It is reset to zero when the cumulative cuts consumed is larger than the previous week's cumulative cuts. If the cuts exist for the current week, then the cumulative cuts is set to the current week's cuts instead of zero. This matrix is intended to track quantities that become non-cancelable across cycles as a result of reductions in demand inside the liability horizon.

$${CumCuts}_{h , c} = \{ \begin{matrix}{CumCuts}_{h , c - 1} + {Cuts}_{h , c} , & if ( {CumCuts}_{h , c - 1} + {CumCutsCons}_{h , c - 1} ) < 0 \\ 0 , & if ( {CumCuts}_{h , c - 1} + {CumCutsCons}_{h , c - 1} ) \geq \\ & 0 and {Cuts}_{h , c} > 0 \\ {Cuts}_{h , c} , & if ( {CumCuts}_{h , c - 1} + {CumCutsCons}_{h , c - 1} ) \geq \\ & 0 and {Cuts}_{h , c} \leq 0\end{matrix} \}$$

where, h is the liability horizon expressed in weeks, and c is the cycle being calculated.

1.1.3 Cumulative Cuts Consumed

Cumulative cuts consumed is a bi-dimensional matrix calculating the cumulative effect of “fresh” demands entering into the liability horizon on the current cycle. For example, in a four (4) week liability horizon, the fourth week demand is, for the first time, inside the liability horizon, i.e., during the previous cycle, this demand was outside of the liability horizon. The fourth week then is considered a “fresh” demand.

According to a preferred embodiment of the present invention, the cumulative cuts consumed is reset to the current cycle “fresh” demands if the previous weeks cumulative cuts consumed is larger than the cumulative cuts. This matrix is intended to track “fresh” quantities entering into the liability horizon every cycle. The “fresh” demand is one way to consume the “non-cancelable” quantity created by cumulative cuts inside the liability horizon.

$${CumCutsCons}_{h , c} = \{ \begin{matrix}{CumCutsCons}_{h , c - 1} + {Req}_{c + h - 1 , c} , & if ( {CumCuts}_{h , c - 1} + \\ & {CumCutsCons}_{h , c - 1} ) < 0 \\ {Req}_{c + h - 1 , c} , & if ( {CumCuts}_{h , c - 1} + \\ & {CumCutsCons}_{h , c - 1} ) \geq 0\end{matrix} \}$$

where, h is the liability horizon expressed in weeks, and c is the cycle being calculated.

1.1.4 To Go

To Go is a bi-dimensional matrix defined as that demand outside of the liability horizon for the current cycle. This matrix is intended to track the demands outside of the liability horizon. The To Go demand can be used to potentially consume “non-cancelable” quantities.

$${ToGo}_{h , c} = {\sum }_{n = h + 2}^{n = ∞} {Req}_{n , c}$$

where, h is the liability horizon expressed in weeks, and c is the cycle being calculated.

1.1.5 Cumulative Excess

Cumulative Excess is a bi-dimensional matrix that represents the cumulative effect of the various elements described above. The cumulative excess is the sum of the cumulative cuts, cumulative cuts consumed and To Go matrices described above. A negative number indicates the excess quantity for the specified liability horizon.
CumXs_{h,c}=CumCuts_{h,c}+CumCutsCons_{h,c}+ToGo_{h,c}
where, h is the liability horizon expressed in weeks, and c is the cycle being calculated.

1.2 Formulas for Non-Cancelable Component

1.2.1 Cumulative Actuals

Cumulative Actuals is a one dimensional matrix and is defined as the cumulative actual pulls from the distribution hub since the commodity's launch. The matrix is used mainly as a reference to what has been built during the life of the commodity or during specific periods of time.
CumAct_{c}=CumAct_{c-1}+Req_{c-1,c}
where, c is the cycle of interest.

1.2.2 Manufacturing Lead Time Required Quantity

The Manufacturing Lead Time (MLT) Required Quantity is a bi-dimensional matrix. Under contract terms for a “non-cancelable” component, the product developer will place orders for the commodity only according to the MLT for the commodity. Thus, the MLT for the commodity is used to track the liability horizon.

$${MLTQty}_{l , c} = {\sum }_{n = c + 1}^{n = l + 1} {Req}_{n , c}$$

where, l is the MLT Horizon expressed in weeks, and c is the cycle being calculated.

1.2.3 Cumulative Non-Cancelable

Cumulative Non-Cancelable is a bi-dimensional matrix that keeps track of the peak “Non-Cancelable” demands and is based on the maximum value between the MLT Required Quantities occurring in the current cycle and the previous cycle's Cumulative Non-Cancelable quantity. The Cumulative Actuals for the current cycle are subtracted from the previous cycle's Cumulative Non-Cancelable before calculating the previously described maximum value.

$${CumNC}_{l , c} = \{ \begin{matrix}{CumNC}_{l , c - 1} - {Req}_{c - 1 , c} , & if ( {CumNC}_{l , c - 1} - \\ & {Req}_{c - 1 , c} ) > {MLTQty}_{l , c} \\ {MLTQty}_{l , c} , & if ( {CumNC}_{l , c - 1} - \\ & {Req}_{c - 1 , c} ) \leq {MLTQty}_{l , c}\end{matrix} \}$$

where, l is the MLT Horizon expressed in weeks, and c is the cycle being calculated.

1.2.4 Non-Cancelable To Go

Non-Cancelable To Go is a one dimensional matrix that represents the total demands for the current cycle, starting the current week and extending to infinity.

$${NCToGo}_{c} = {\sum }_{n = c}^{n = ∞} {Req}_{n , c}$$

c is the cycle being calculated.

1.2.5 Non-Cancelable Cumulative Excess

Non-Cancelable Cumulative Excess is the algebraic subtraction of the variables Non-Cancelable To Go and Cumulative Non-Cancelable. A negative number represents excess quantity for the specified liability horizon.
NCumXs_{l,c}=NCToGo_{c}−CumNC_{l,c}
where, l is the Mfg Lead Time Horizon expressed in weeks, and c is the cycle being calculated.

2. Dollar Figures Calculation Formulas

The set of formulas described below are used to calculate the dollar figures based on the quantities calculated according to the Excess Quantity Calculation Formulas and the Liability Profile.

2.1 Cancelable Component Dollar Amount Excess

The Cancelable Component Dollar Amount Excess is a bi-dimensional matrix that calculates the Dollar amount for a specified liability horizon. The amount is based on the Cumulative Excess and the Cumulative Extended Cost shown in the Liability Profile.

$${Amount}_{h , c} = \{ \begin{matrix}0 , & if Cum {Xs}_{h , c} \geq 0 \\ 0 , & if {CumXs}_{h , c} < 0 and \\ & ( {CumXs}_{h - 1 , c} - {CumXs}_{h , c} ) \leq 0 \\ ( {CumXs}_{h - 1 , c} - {CumXs}_{h , c} ) * & if {CumXs}_{h , s} < 0 and \\ {Profile}_{h} * TotProfile , & ( {CumXs}_{h - 1 , c} - {CumXs}_{h , c} ) > 0\end{matrix} \}$$

where, h is the liability horizon expressed in weeks, and c is the cycle being calculated.

2.2 Non-Cancelable Component Dollar Amount Excess

The Non-Cancelable Component Dollar Amount Excess is a bi-dimensional matrix calculating the Dollar figures for the “Non-Cancelable” Component for the specified MLT is is based on the Cumulative Excess and the Non-Cancelable Cumulative Extended Cost shown in the Liability Profile.

$${NC Amount}_{l , c} = \{ \begin{matrix}0 , & if NCum {Xs}_{l , c} \geq 0 \\ 0 , & if {NCumXs}_{l , c} < 0 and \\ & ( {NCumXs}_{l - 1 , c} - {NCumXs}_{l , c} ) \leq 0 \\ ( {NCumXs}_{l - 1 , c} - {NCumXs}_{l , c} ) * & if {NCumXs}_{l , c} < 0 and \\ {Profile}_{l} * TotProfile , & ( {NCumXs}_{l - 1 , c} - {NCumXs}_{l , c} ) > 0\end{matrix} \}$$

where, l is the MLT Horizon expressed in weeks, and c is the cycle being calculated.

2.3 Total Dollar Amount Excess

Total Dollar Amount Excess is a one dimensional matrix that calculates the total Excess Amount for a specific cycle, and is the sum of Dollar Amount Excess for all the Liability Horizons for Cancelable and Non-Cancelable sub-components.

$${TotAmount}_{c} = {\sum }_{n = 0}^{n = ∞} {Amount}_{n , c} + {\sum }_{n = 0}^{n = ∞} {NCAmount}_{n , c}$$

where, c is the cycle being calculated.

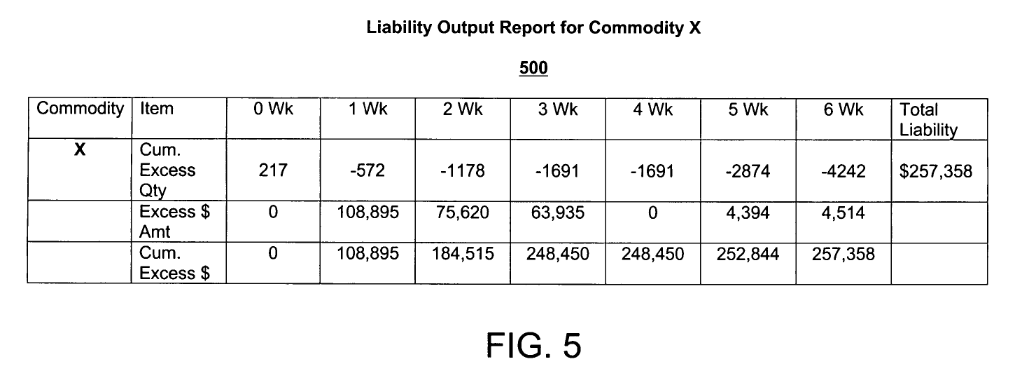

Referring again to FIG. 2, once the above described calculations are performed, the liability management tool 40 generates a liability output report 50 in step 212. FIG. 5 illustrates is an exemplary liability output report 500 according to a preferred embodiment of the present invention. The quantities are calculated for a particular cycle over a series of liability horizons, expressed in weeks. In a preferred embodiment, the liability output report 500 includes the cumulative excess quantity for the liability horizons (0 to 6 weeks). The report 500 also includes the excess dollar amounts corresponding to the liability incurred for the excess units created within a particular liability horizon. Finally, the report 500 includes cumulative excess dollars, which indicates the total rolling liability from liability horizon to liability horizon.

As is shown in FIG. 5, at liability horizon week 0, the cumulative excess quantity is a positive 217 units, which indicates that an excess inventory does not exist for that particular liability horizon. For the one week liability horizon, however, the cumulative excess quantity is a negative 572, which indicates that an excess of 572 units exists due to fluctuating demand within the liability horizon. The liability associated with the excess quantity is $108,895, which is calculated from the commodity's liability profile. At the two week liability horizon, the cumulative excess quantity grows by 606 units to negative 1178. The excess dollar amount associated with the additional 606 units is $75,620, which is indicative of the fact that at least one sub-component has a cancellation window within the two week time window. As the weeks progress, the cumulative excess quantities increase along with the cumulative excess dollars. The last column in the output report 500 indicates the total liability for excess quantities incurred by the product developer.

The liability output report 500 is useful to the product developer in many ways. First, the product developer can utilize the liability output report 500 to decide that it is desirable to adjust future demand forecasts to build-out an additional 1,691 units in order to mitigate $248,450 of the $257,358 total liability. In a preferred embodiment, the liability management tool 40 can be used to run hypothetical demand forecasts so that the product developer can determine how the liability output report is affected by certain demand forecasting. The product developer can also use the liability output report 500 to plan promotional activities to mitigate the liability. In addition, the liability output report 500 can be used to validate or challenge supplier liability claims quickly and accurately, or to initiate negotiations to reduce such liability.

In short, the liability output report 500 generated by the liability management tool 40 allows the product developer to manage proactively its potential exposure to liability created by demand forecast fluctuations. The liability management tool according to the preferred embodiment of the present invention allows the product developer to predict and quantify liability so that mitigation actions can be implemented.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

1. A method for managing excess inventory of a commodity comprising:
a) creating a profile for the commodity;
b) creating a waterfall template for the commodity; and
c) analyzing the profile and the waterfall template to generate an output report, wherein the output report indicates the excess inventory and associated liability for a plurality of liability horizons.

2. The method of claim 1, wherein the profile is a liability profile that comprises a plurality of cancellation windows, each of which indicate a level of liability associated with excess inventory existing within each cancellation window.

3. The method of claim 2, wherein step (a) further includes:
(a1) collecting commodity cost information including contract terms and conditions, unit costs, and bills-of-material information.

4. The method of claim 1, wherein the waterfall template represents a number of units ordered over a fixed period and a number of units consumed during the fixed period.

5. The method of claim 4, wherein step (b) further includes:
(b1) collecting current and past demand forecast data, wherein demand forecast data comprises the number of units ordered on a weekly basis for a cycle comprising a set number of weeks; and
(b2) collecting current and past consumption data, wherein consumption data comprises the number of units consumed during a cycle.

6. The method of claim 1 further comprising:
d) utilizing the output report to manage the excess inventory.

7. The method of claim 6, wherein step (d) further comprises:
d1) adjusting a future demand forecast to mitigate partially or entirely the liability associated with the excess inventory.

8. The method of claim 6, wherein step (d) further comprises:
d1) submitting a hypothetical demand forecast to determine an effect upon the excess inventory and the associated liability.

9. The method of claim 6, wherein step (d) further comprises:
d1) planning a promotional activity to increase consumption of the commodity.

10. The method of claim 6, wherein step (d) further comprises:
d1) validating a claim for the liability associated with the excess inventory.

11. A computer readable medium containing program instructions for managing excess inventory of a commodity, the program instructions for:
a) creating a profile for the commodity;
b) creating a waterfall template for the commodity; and
c) analyzing the profile and the waterfall template to generate an output report, wherein the output report indicates the excess inventory and associated liability for a plurality of liability horizons.

12. The computer readable medium of claim 11, wherein the profile is a liability profile that comprises a plurality of cancellation windows, each of which indicate a level of liability associated with excess inventory existing within each cancellation window.

13. The computer readable medium of claim 12, wherein instruction (a) further includes:
(a1) collecting commodity cost information including contract terms and conditions, unit costs, and bills-of-material information.

14. The computer readable medium of claim 11, wherein the waterfall template represents a number of units ordered over a fixed period and a number of units consumed during the fixed period.

15. The computer readable medium of claim 14, wherein instruction (c) further includes:
(c1) collecting current and past demand forecast data, wherein demand forecast data comprises the number of units ordered on a weekly basis for a cycle comprising a set number of weeks; and
(c2) collecting current and past consumption data, wherein consumption data comprises the number of units consumed during a cycle.

16. The computer readable medium of claim 11 further comprising:
d) utilizing the output report to manage the excess inventory.

17. The computer readable medium of claim 16, wherein instruction (d) further comprises:
d1) adjusting a future demand forecast to mitigate partially or entirely the liability associated with the excess inventory.

18. The computer readable medium of claim 16, wherein step (d) further comprises:
d1) submitting a hypothetical demand forecast to determine an effect upon the excess inventory and the associated liability.

19. The computer readable medium of claim 16, wherein instruction (d) further comprises:
d1) planning a promotional activity to increase consumption of the commodity.

20. The computer readable medium of claim 15, wherein instruction (d) further comprises:
d1) validating a claim for the liability associated with the excess inventory.

21. A system for managing excess inventory of a commodity comprising:
a processor;
a liability management tool coupled to the processor, wherein the liability management tool is configured to create a profile for the commodity, to create a waterfall template for the commodity, and to analyze the profile and the waterfall template to generate an output report, wherein the output report indicates the excess inventory and associated liability for a plurality of liability horizons.

22. The system of claim 21, wherein the profile is a liability profile that comprises a plurality of cancellation windows, each of which indicate a level of liability associated with excess inventory existing within each cancellation window.

23. The system of claim 21, wherein the waterfall template represents a number of units ordered over a fixed period and a number of units consumed during the fixed period.

24. The system of claim 21, wherein the liability management tool comprises means for retrieving commodity cost information including contract terms and conditions, unit costs, and bills-of-material information, current and past demand forecast data, wherein demand forecast data comprises the number of units ordered on a weekly basis for a cycle comprising a set number of weeks, and collecting current and past consumption data, wherein consumption data comprises the number of units consumed during a cycle.
